(19) United States
(12) Patent Application Publication
(10) Pub. No.: US 2022/0386168 A1
(43) Pub. Date: Dec. 1, 2022

(54) CONGESTION CONTROL BASED ON MOTION STATE

(71) Applicant: QUALCOMM Incorporated, San Diego, CA (US)

(72) Inventors: Lan YU, Beijing (CN); Dan VASSILOVSKI, Del Mar, CA (US); Hong CHENG, Basking Ridge, NJ (US); Gavin Bernard HORN, La Jolla, CA (US); Shailesh PATIL, San Diego, CA (US)

(21) Appl. No.: 17/754,347

(22) PCT Filed: Oct. 28, 2019
(86) PCT No.: PCT/CN2019/113572

§ 371 Date: Mar. 30, 2022

(51) Int. Cl. H04W 28/02; H04L 5/00; H04W 76/14

(52) U.S. Cl. CPC H04W 28/0289; H04W 28/0242; H04L 5/0094; H04W 76/14

(57) ABSTRACT

Various aspects of the present disclosure generally relate to wireless communication. In some aspects, a method of wireless communication, performed by a user equipment (UE), may include determining an inter-transmission time value for a series of transmissions to be performed by the UE; adjusting the inter-transmission time value based at least in part on a motion state associated with the UE; and performing the series of transmissions in accordance with the adjusted inter-transmission time value. Numerous other aspects are provided.

### TECHNICAL FIELD

Aspects of the technology described below generally relate to wireless communication and to techniques and apparatuses for congestion control based at least in part on a motion state of a user equipment (UE). Some techniques and apparatuses described herein enable and provide wireless communication devices and systems configured for improved spectral efficiency, capacity, and data rates.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, and/or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless communication network may include a number of base stations (BSs) that can support communication for a number of user equipment (UEs). A user equipment (UE) may communicate with a base station (BS) via the downlink and uplink. The downlink (or forward link) refers to the communication link from the BS to the UE, and the uplink (or reverse link) refers to the communication link from the UE to the BS. ABS may be referred to as a Node B, a gNB, an access point (AP), a radio head, a transmit receive point (TRP), a new radio (NR) B S, a 5G Node B, and/or the like.

Multiple access technologies have been adopted in various telecommunication standards. Wireless communication standards provide common protocols to enable different devices (e.g., user equipment) to communicate on a municipal, national, regional, and even global level. New radio (NR), which may also be referred to as 5G, is a set of enhancements to the LTE mobile standard promulgated by the Third Generation Partnership Project (3GPP). As demand for mobile broadband access continues to increase, there exists a need for further improvements in LTE and NR technologies. These improvements can apply to other multiple access technologies and the telecommunication standards that employ these technologies.

### BRIEF SUMMARY OF SOME EXAMPLES

The following summarizes some aspects of the present disclosure to provide a basic understanding of the discussed technology. This summary is not an extensive overview of all contemplated features of the disclosure, and is intended neither to identify key or critical elements of all aspects of the disclosure nor to delineate the scope of any or all aspects of the disclosure. The purpose of the summary is to present some concepts of one or more aspects of the disclosure in summary form as a prelude to the more detailed description that is presented later.

A UE may perform a periodic transmission for various purposes. For example, in a cellular vehicle-to-anything (CV2X) deployment, a UE associated with a vehicle may periodically transmit a message, such as a basic safety message (BSM), to inform other CV2X-capable vehicles of static and dynamic conditions of the UE or the vehicle associated with the UE. As used herein, a CV2X-capable vehicle may refer to a vehicle associated with a UE capable of performing CV2X communications.

In some conditions, dense traffic scenarios may arise. For example, a congested street with many CV2X-capable vehicles may lead to large volumes of messages being transmitted, resulting in over-the-air (OTA) congestion of a channel used by the CV2X-capable vehicles to communicate. Thus, congestion control is an important part of CV2X system design, to reduce collisions of messages and to avoid the loss of safety-critical messages. Since CV2X communication does not use a central scheduling entity, such as a base station, distributed congestion control (DCC) techniques may be used.

Different CV2X-capable vehicles may be associated with different operating conditions. For example, one CV2X-capable vehicle may be traveling more quickly, maneuvering more aggressively, or navigating through traffic more riskily than another CV2X-capable vehicle. A periodic message transmitted by the two CV2X-capable vehicles, such as a BSM, may convey speed information, location information, direction information, and/or the like. However, when two CV2X-capable vehicles have different operating conditions, using the same parameters for periodic transmissions of the two vehicles may be sub-optimal. For example, on a straight road, vehicles moving at high speed or with high acceleration present a greater risk than vehicles moving at slow or constant speed. If a vehicle moving at high speed or with high acceleration provides periodic messages, such as BSM messages, at the same periodicity as a vehicle moving at low speed or with low acceleration, then other vehicles may receive less granular information about the operating parameters of the vehicle moving at high speed or with high acceleration (e.g., 10 messages in one second for a vehicle moving 100 m/s would provide updates only every 10 m, whereas 10 messages in one second for a vehicle moving 25 m/s would provide updates every 2.5 m).

Some techniques and apparatuses described herein provide adjustment of an inter-transmission time (ITT) for a message periodically transmitted by a UE based at least in part on a motion state of the UE. A UE may determine the ITT based at least in part on channel conditions, such as vehicle congestion, channel congestion, and/or the like. A UE associated with a higher motion state (e.g., a faster speed, a higher acceleration, a faster rotational speed, and/or the like) may adjust the ITT to a relatively shorter value than a UE associated with a lower motion state. Thus, UEs that are associated with higher motion states may provide more frequent messages than UEs that are associated with lower motion states, thereby improving safety. Furthermore, the adjustment of ITT may reduce channel congestion in crowded deployment scenarios in comparison to an inflexible approach where all vehicles use the same parameters for periodic message transmission.

In some aspects, a method of wireless communication, performed by a user equipment (UE), may include determining an inter-transmission time value for a series of transmissions to be performed by the UE; adjusting the inter-transmission time value based at least in part on a motion state associated with the UE; and performing the series of transmissions in accordance with the adjusted inter-transmission time value.

In some aspects, a UE for wireless communication may include memory and one or more processors operatively coupled to the memory. The memory and the one or more processors may be configured to determine an inter-transmission time value for a series of transmissions to be performed by the UE; adjust the inter-transmission time value based at least in part on a motion state associated with the UE; and perform the series of transmissions in accordance with the adjusted inter-transmission time value.

In some aspects, a non-transitory computer-readable medium may store one or more instructions for wireless communication. The one or more instructions, when executed by one or more processors of a UE, may cause the one or more processors to: determine an inter-transmission time value for a series of transmissions to be performed by the UE; adjust the inter-transmission time value based at least in part on a motion state associated with the UE; and perform the series of transmissions in accordance with the adjusted inter-transmission time value.

In some aspects, an apparatus for wireless communication may include means for determining an inter-transmission time value for a series of transmissions to be performed by the apparatus; means for adjusting the inter-transmission time value based at least in part on a motion state associated with the apparatus; and means for performing the series of transmissions in accordance with the adjusted inter-transmission time value.

Aspects generally include a method, apparatus, system, computer program product, non-transitory computer-readable medium, user equipment, base station, wireless communication device, and/or processing system as substantially described herein with reference to and as illustrated by the accompanying drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description is provided herein, with some aspects of the disclosure being illustrated in the appended drawings. However, the appended drawings illustrate only some aspects of this disclosure and are therefore not to be considered limiting of the scope of the disclosure. The same reference numbers in different drawings may identify the same or similar elements.

FIG. 1 is a block diagram conceptually illustrating an example of a wireless communication network, in accordance with various aspects of the present disclosure.

FIG. 2 is a block diagram conceptually illustrating an example of a base station in communication with a UE in a wireless communication network, in accordance with various aspects of the present disclosure.

FIG. 3 is a diagram illustrating an example of adjustment of an inter-transmission time based at least in part on a motion state of a UE, in accordance with various aspects of the present disclosure.

FIG. 4 is a diagram illustrating another example of adjustment of an inter-transmission time based at least in part on a motion state of a UE, in accordance with various aspects of the present disclosure.

FIG. 5 is a diagram illustrating an example process performed, for example, by a user equipment, in accordance with various aspects of the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, and/or the like (collectively referred to as “elements” or “features”). These elements may be implemented using hardware, software, or combinations thereof. Whether such elements are implemented as hardware or software depends upon the particular application and design constraints imposed on the overall system.

While some aspects may be described herein using terminology commonly associated with 3G and/or 4G wireless technologies, aspects of the present disclosure can be applied in other generation-based communication systems, such as 5G and later, including NR technologies.

While aspects and embodiments are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, embodiments and/or uses may come about via integrated chip embodiments and/or other non-module-component based devices (e.g., end-user devices, vehicles, communication devices, computing devices, industrial equipment, retail/purchasing devices, medical devices, AI-enabled devices, and/or the like). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or original equipment manufacturer devices or systems incorporating one or more aspects of the described innovations. In some practical settings, devices incorporating described aspects and features may also necessarily include additional components and features for implementation and practice of claimed and described embodiments. For example, transmission and reception of wireless signals necessarily includes a number of components for analog and digital purposes (e.g., hardware components including one or more antennas, radio frequency (RF) chains, power amplifiers, modulators, buffers, processors, interleavers, adders/summers, and/or the like). It is intended that innovations described herein may be practiced in a wide variety of devices, chip-level components, systems, distributed arrangements, end-user devices, etc. of varying sizes, shapes, and constitution.

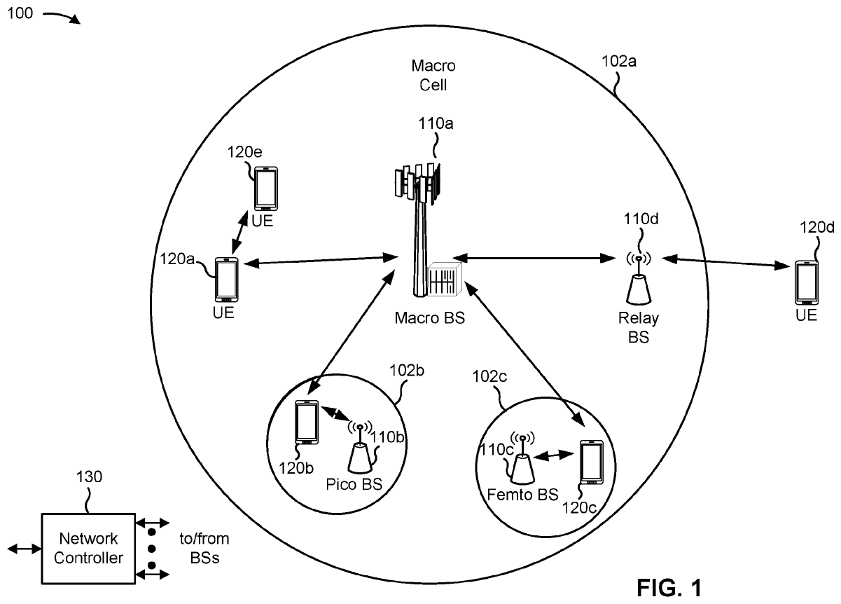

FIG. 1 is a diagram illustrating a wireless network 100 in which aspects of the present disclosure may be practiced. The wireless network 100 may be an LTE network or some other wireless network, such as a 5G or NR network. The wireless network 100 may include a number of BSs 110 (shown as BS 110a, BS 110b, BS 110c, and BS 110d) and other network entities. ABS is an entity that communicates with user equipment (UEs) and may also be referred to as a base station, a NR BS, a Node B, a gNB, a 5G node B (NB), an access point, a transmit receive point (TRP), and/or the like. Each BS may provide communication coverage for a particular area (e.g., a fixed or changing geographical area). In some scenarios, BSs 110 may be stationary or non-stationary. In some non-stationary scenarios, mobile BSs 110 may move with varying speeds, direction, and/or heights. In 3GPP, the term “cell” can refer to a coverage area of a BS 110 and/or a BS subsystem serving this coverage area, depending on the context in which the term is used.

A BS may provide communication coverage for a macro cell, a pico cell, a femto cell, and/or another type of cell. A macro cell may cover a relatively large geographic area (e.g., several kilometers in radius) and may allow unrestricted access by UEs with service subscription. Additionally, or alternatively, a BS may support access to an unlicensed RF band (e.g., a Wi-Fi band and/or the like). A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). A BS for a macro cell may be referred to as a macro BS. A BS for a pico cell may be referred to as a pico BS. A BS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. ABS may support one or multiple (e.g., three) cells. The terms “eNB”, “base station”, “NR BS”, “gNB”, “TRP”, “AP”, “node B”, “5G NB”, and “cell” may be used interchangeably herein.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces such as a direct physical connection, a virtual network, and/or the like using any suitable transport network. In other scenarios, BSs may be implemented in a software defined network (SDN) manner or via network function virtualization (NFV) manner.

Wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay station 110d may communicate with macro BS 110a and a UE 120d in order to facilitate communication between BS 110a and UE 120d. A relay station may also be referred to as a relay BS, a relay base station, a relay, and/or the like.

Wireless network 100 may be a heterogeneous network that includes BSs of different types, e.g., macro BSs, pico BSs, femto BSs, relay BSs, and/or the like. These different types of BSs may have different transmit power levels, different coverage areas, and different impacts on interference in wireless network 100. For example, macro BSs may have a high transmit power level (e.g., 5 to 40 Watts) whereas pico BSs, femto BSs, and relay BSs may have lower transmit power levels (e.g., 0.1 to 2 Watts).

A network controller 130 may couple to a set of BSs and may provide coordination and control for these BSs. Network controller 130 may communicate with the BSs via a backhaul. The BSs may also communicate with one another, e.g., directly or indirectly via a wireless or wireline backhaul.

UEs 120 (e.g., 120a, 120b, 120c) may be dispersed throughout wireless network 100, and each UE may be stationary or mobile. A UE may also be referred to as an access terminal, a terminal, a mobile station, a subscriber unit, a station, and/or the like. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, robotics, drones, implantable devices, augmented reality devices, a global positioning system device, or any other suitable device that is configured to communicate via a wireless or wired medium.

Some UEs may be considered machine-type communication (MTC) or evolved or enhanced machine-type communication (eMTC) UEs. MTC and eMTC UEs include, for example, robots, drones, remote devices, sensors, meters, monitors, location tags, and/or the like, that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, and/or may be implemented as may be implemented as NB-IoT (narrowband internet of things) devices. Some UEs may be considered a Customer Premises Equipment (CPE). UE 120 may be included inside a housing that houses components of UE 120, such as processor components, memory components, and/or the like. These components may be integrated in a variety of combinations and/or may be stand-alone, distributed components considering design constraints and/or operational preferences.

In general, any number of wireless networks may be deployed in a given geographic area. Each wireless network may support a particular RAT and may operate on one or more frequencies. A RAT may also be referred to as a radio technology, an air interface, and/or the like. A frequency may also be referred to as a carrier, a frequency channel, and/or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, and/or the like), a mesh network, and/or the like. In this case, UE 120 may perform scheduling operations, resource selection operations, and/or other operations described elsewhere herein as being performed by the base station 110. A UE performing scheduling operations can include or perform base-station-like functions in these deployment scenarios.

As indicated above, FIG. 1 is provided merely as an example. Other examples may differ from what is described with regard to FIG. 1.

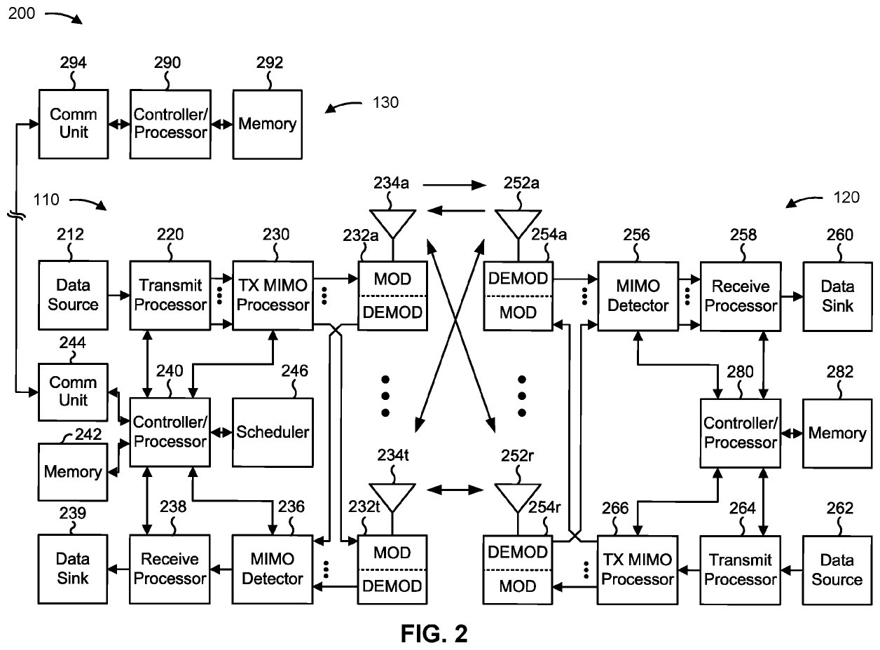

FIG. 2 shows a block diagram of a design 200 of base station 110 and UE 120, which may be one of the base stations and one of the UEs in FIG. 1. Base station 110 may be equipped with T antennas 234a through 234t, and UE 120 may be equipped with R antennas 252a through 252r, where in general T>1 and R>1. The T and R antennas may be configured with multiple antenna elements formed in an array for MIMO or massive MIMO deployments that can occur in millimeter wave (mmWave or mmW) communication systems.

At base station 110, a transmit processor 220 can carry out a number of functions associated with communications. For example, transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI) and/or the like) and control information (e.g., CQI requests, grants, upper layer signaling, and/or the like) and provide overhead symbols and control symbols. Transmit processor 220 may also generate reference symbols for reference signals (e.g., the cell-specific reference signal (CRS)) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for orthogonal frequency division multiplexing (OFDM) and/or the like) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively. According to various aspects described in more detail below, the synchronization signals can be generated with location encoding to convey additional information.

At UE 120, antennas 252a through 252r may receive downlink RF signals. The downlink RF signals may be received from and/or may be transmitted by one or more base stations 110. The signals can be provided to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 120 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like. In some aspects, one or more components of UE 120 may be included in a housing.

For uplink communications, a UE 120 may transmit control information and/or data to another device, such as one or more base stations 110. For example, at UE 120, a transmit processor 264 may receive and process data from a data source 262 and control information (e.g., for reports comprising RSRP, RSSI, RSRQ, CQI, and/or the like) from controller/processor 280. Transmit processor 264 may also generate reference symbols for one or more reference signals. The symbols from transmit processor 264 may be precoded by a TX MIMO processor 266 if applicable, further processed by modulators 254a through 254r (e.g., for DFT-s-OFDM, CP-OFDM, and/or the like), and transmitted to base station 110. At base station 110, the uplink signals from UE 120 and other UEs may be received by antennas 234, processed by demodulators 232, detected by a MIMO detector 236 if applicable, and further processed by a receive processor 238 to obtain decoded data and control information sent by UE 120. Receive processor 238 may provide the decoded data to a data sink 239 and the decoded control information to controller/processor 240. Base station 110 may include communication unit 244 and communicate to network controller 130 via communication unit 244. Network controller 130 may include communication unit 294, controller/processor 290, and memory 292.

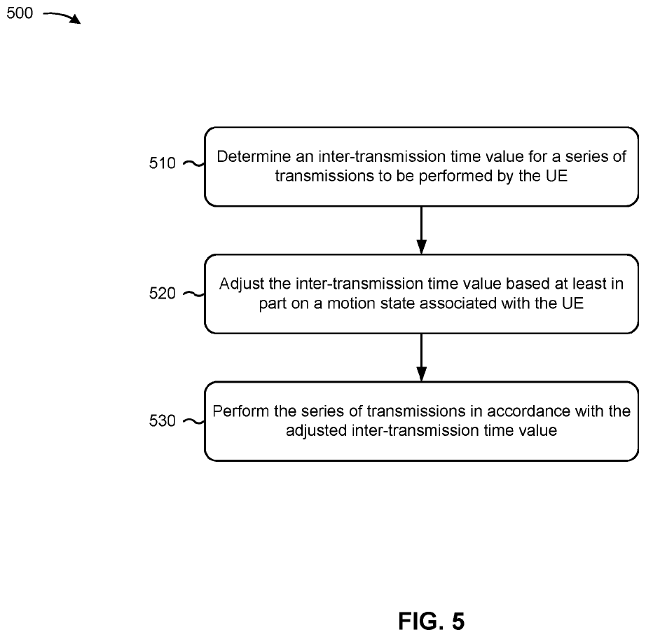

Controller/processor 240 of base station 110, controller/processor 280 of UE 120, and/or any other component(s) of FIG. 2 may perform one or more techniques associated with congestion control based at least in part on a motion state of a UE, as described in more detail elsewhere herein. For example, controller/processor 240 of base station 110, controller/processor 280 of UE 120, and/or any other component(s) of FIG. 2 may perform or direct operations of, for example, process 500 of FIG. 5 and/or other processes as described herein. Memories 242 and 282 may store data and program codes for base station 110 and UE 120, respectively. A scheduler 246 may schedule UEs for data transmission on the downlink and/or uplink.

In some aspects, UE 120 may include a variety of means or components for implementing communication functions. For example, the variety of means may include means for determining an inter-transmission time value for a series of transmissions to be performed by UE 120, means for adjusting the inter-transmission time value based at least in part on a motion state associated with UE 120, means for performing the series of transmissions in accordance with the adjusted inter-transmission time value, means for adjusting the inter-transmission time based at least in part on one or more threshold speed values, means for adjusting the inter-transmission time based at least in part on a direction associated with a turn performed by a vehicle associated with UE 120, and/or the like.

In some aspects, UE 120 may include a variety of structural components for carrying out functions of the various means. For example, structural components that carry out functions of such means may include one or more components of UE 120 described in connection with FIG. 2, such as antenna 252, DEMOD 254, MOD 254, MIMO detector 256, receive processor 258, transmit processor 264, TX MIMO processor 266, controller/processor 280, and/or the like.

As indicated above, FIG. 2 is provided merely as an example. Other examples may differ from what is described with regard to FIG. 2.

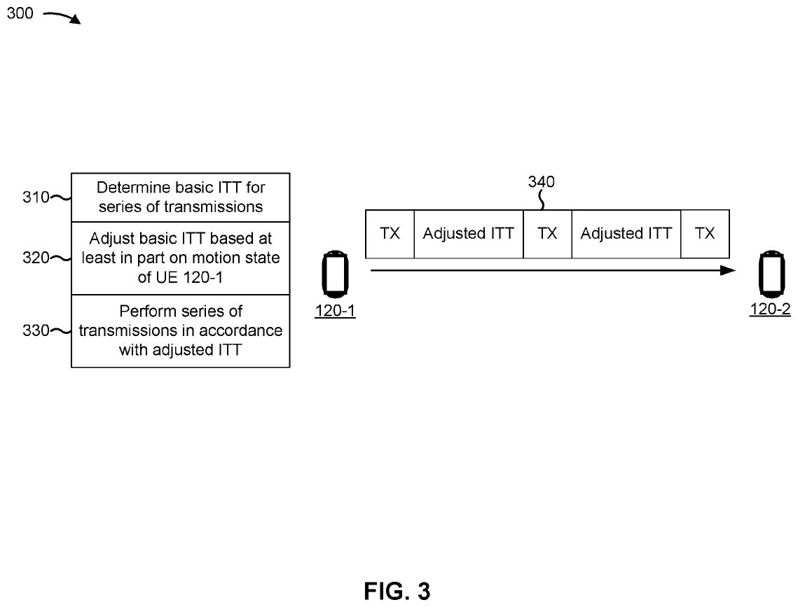

FIG. 3 is a diagram illustrating an example 300 of adjustment of an inter-transmission time based at least in part on a motion state of a UE, in accordance with various aspects of the present disclosure. As shown, example 300 includes a UE 120-1 and a UE 120-2. In some aspects, UE 120-1 and UE 120-2 may be associated with a CV2X deployment (e.g., may be associated with or installed in CV2X-capable vehicles), though the techniques described herein can be used in other types of deployments other than CV2X.

As shown by reference number 310, UE 120-1 may determine a basic ITT for a series of transmissions. The basic ITT, also referred to herein as the initial ITT, may refer to an ITT value that has not been adjusted based at least in part on a motion state of UE 120-1, or to an ITT value that is determined based at least in part on channel conditions and not the motion state of UE 120-1. In some aspects, UE 120-1 may determine the basic ITT based at least in part on a channel condition associated with UE 120-1, such as a channel busy rate (CBR), a reference signal determination, a signal-to-noise ratio, a transmitter density, and/or the like.

In some aspects, UE 120-1 may determine the basic ITT based at least in part on a vehicle density threshold associated with UE 120-1. For example, a standard (e.g., Society of Automotive Engineering (SAE) 3161, which defines on-board system requirements for LTE vehicle-to-vehicle (V2V) safety communication) may define an effective application-layer DCC technique. This technique may be based at least in part on a traffic environment surrounding UE 120-1 within a threshold range and time. The parameters used for the DCC technique include CBR, vehicle density, and others. This standard may indicate that ITT is determined based at least in part on vehicle density. For example, UE 120-1 may increase the ITT if the vehicle density satisfies a threshold. In some aspects, UE 120-1 may determine vehicle density based at least in part on receiving messages from other vehicles or other UEs 120, such as BSMs and/or the like.

In some aspects, UE 120-1 may determine one or more parameters for the series of transmissions, such as a transmission range (e.g., a radiated power adjustment based at least in part on a CBR) and/or the like. For example, UE 120-1 may reduce a radiated power of UE 120-1 if a CBR of UE 120-1 satisfies a threshold.

In some aspects, UE 120-1 may determine a basic ITT value based at least in part on a vehicle density threshold. For example, UE 120-1 may determine the basic ITT value (ITT_{basic}) using the following Equation 1:

$${ITT}_{basic} = \{ \begin{matrix}{ITT}_{ref} & vn \leq {Th}_{1} \\ {ITT}_{ref} \times \frac{vn}{{Th}_{1}} & {Th}_{1} < vn < {Th}_{2} \\ {ITT}_{max} & vn \geq {Th}_{2}\end{matrix} . \qquad Equation 1$$

In Equation 1, ITT_{ref} and ITTₘₐₓ define a possible range of the ITT value. The value vn is an observed number of vehicles within a threshold range of UE 120-1. Th₁ and Th₂ are thresholds for vehicle density.

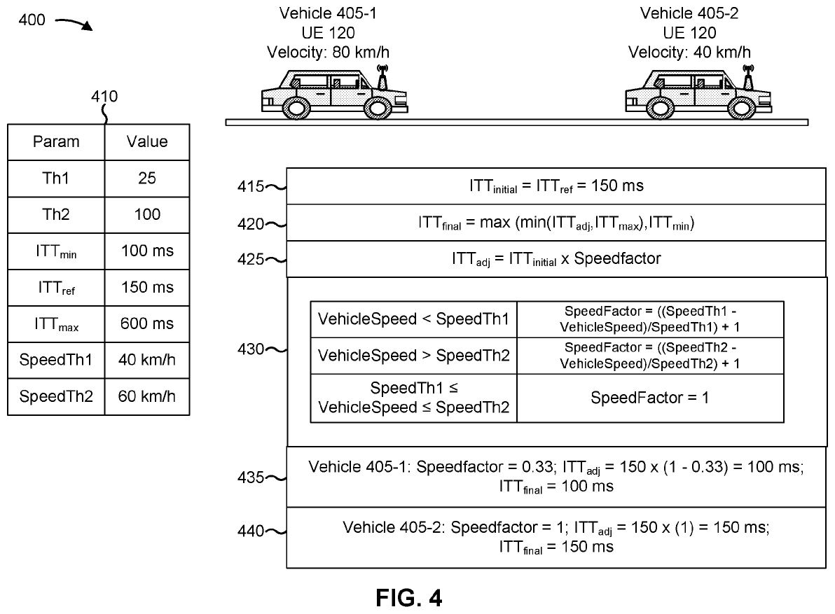

As shown by reference number 320, UE 120-1 may adjust the basic ITT (e.g., the initial ITT) based at least in part on a motion state of UE 120-1. For example, UE 120-1 may increase or decrease the ITT based at least in part on the motion state of UE 120-1. FIG. 4 shows an example of adjusting the basic ITTs of a first vehicle and a second vehicle based at least in part on respective motion states of the first vehicle and the second vehicle. UE 120-1 may receive information identifying the motion state from a system of the corresponding vehicle. Additionally, or alternatively, UE 120-1 may determine information identifying the motion state (e.g., using a sensor of UE 120-1).

In some aspects, UE 120-1 may adjust the basic ITT based at least in part on a speed of a vehicle. For example, UE 120-1 may increase the ITT (leading to less frequent transmissions) for a lower-speed vehicle, and may decrease the ITT for a higher-speed vehicle. Thus, higher-speed vehicles may provide more frequent updates. More frequent updating by higher-speed vehicles may improve vehicle safety. Furthermore, lower-speed vehicles may provide less frequent updates than higher-speed vehicles. Less frequent updating by lower-speed vehicles may reduce channel congestion.

In some aspects, UE 120-1 may adjust the basic ITT based at least in part on a direction of a vehicle, such as a direction of a turn. For example, UE 120-1 may increase the ITT (leading to less frequent transmissions) for a vehicle turning in a first direction or continuing in a straight line, and may decrease the ITT for a vehicle turning in a second direction. Thus, vehicles turning in a higher-risk direction, such as a left turn across traffic, may provide more frequent updates. This may improve vehicle safety. Furthermore, vehicles performing a lower-risk maneuver may provide less frequent updates, which may reduce channel congestion.

In some aspects, UE 120-1 may adjust the basic ITT based at least in part on a rotational speed of a vehicle, such as associated with a sharp turn. For example, UE 120-1 may increase the ITT (leading to less frequent transmissions) for a vehicle performing a less sharp turn, and may decrease the ITT for a vehicle performing a sharper turn. Thus, vehicles performing a higher-risk maneuver may provide more frequent updates. This may improve vehicle safety. Furthermore, vehicles performing a lower-risk maneuver may provide less frequent updates, which may reduce channel congestion.

In some aspects, UE 120-1 may adjust the basic ITT based at least in part on an acceleration of a vehicle, such as a linear acceleration. For example, UE 120-1 may increase the ITT (leading to less frequent transmissions) for a vehicle associated with a lesser magnitude of acceleration, and may decrease the ITT for a vehicle associated with a greater magnitude of acceleration. Thus, vehicles accelerating more aggressively may provide more frequent updates. This may improve vehicle safety. Furthermore, vehicles accelerating less aggressively or not accelerating may provide less frequent updates, which may reduce channel congestion.

In some aspects, UE 120-1 may use a combination of two or more of the above factors to determine the adjustment to the basic ITT. For example, UE 120-1 may use an average ITT value, a minimum ITT value, and/or the like, determined using the combination of two or more of the above factors. In some aspects, UE 120-1 may use a factor in addition or as an alternative to one or more of the above factors, such as quality of service (QoS) information (e.g., for a unicast or groupcast scenario) and/or the like.

As shown by reference number 330, UE 120-1 may perform the series of transmissions in accordance with the adjusted ITT. For example, as shown by reference number 340, UE 120-1 may perform a first transmission (TX), may wait for a period of time defined by the adjusted ITT, may perform a second TX, and so on. The transmission may include any message. In some aspects, the transmission may be a BSM and/or the like.

In some aspects, UE 120-1 may update the adjusted ITT. For example, UE 120-1 may update the adjusted ITT periodically (e.g., after a certain length of time or a certain number of transmissions). As another example, UE 120-1 may update the adjusted ITT based at least in part on a change in the motion state of UE 120-1 (e.g., when the motion state of UE 120-1 changes by a threshold amount).

Thus, DCC is provided for a CV2X deployment based at least in part on motion states of UEs 120. This reduces channel congestion and improves safety.

While the techniques and apparatuses described herein are primarily described with regard to adjusting an ITT value, the techniques and apparatuses described herein can also be used to adjust other transmission parameters of UE 120, such as a radiated power, a repetition configuration, and/or the like.

As indicated above, FIG. 3 is provided as an example. Other examples may differ from what is described with respect to FIG. 3.

FIG. 4 is a diagram illustrating another example 400 of adjustment of an inter-transmission time based at least in part on a motion state of a UE, in accordance with various aspects of the present disclosure. As shown, example 400 includes vehicles 405-1 and 405-2. Vehicles 405 are associated with respective UEs 120. In some aspects, vehicles 405-1 and 405-2 may be CV2X-capable vehicles. In the description associated with FIG. 4, reference to UE 120 may refer to the UEs 120 associated with one or more of vehicles 405-1 and 405-2, depending on the context. In example 400, the determination of the adjusted ITT value is based at least in part on a speed of vehicle 405 and/or UE 120.

As shown by reference number 410, UE 120 may be configured with a set of parameters for determining the adjusted ITT value. For example, the parameters include Th₁ and Th₂ (described in more detail in connection with FIG. 3) values of 25 and 100, an ITTₘᵢₙ value of 100 ms, an ITTₘₐₓ value of 600 ms, and an ITT_{ref} value of 150 ms. The ITT_{ref} value may define the lower bound for the initial ITT value, and the ITTₘᵢₙ value may define the lower bound for the adjusted ITT value. Furthermore, UE 120 is configured with speed thresholds (SpeedTh1 and SpeedTh2) used to determine the adjustment of the initial ITT value, as described below.

In some aspects, UE 120 may be configured with the set of parameters. For example, an on-board unit of vehicle 405 and/or UE 120 may be configured with the set of parameters (e.g., based at least in part on an application-layer standard). In some aspects, UE 120 may be configured by a network (e.g., a roadside unit, a base station, and/or the like). In this case, the configuration may be based at least in part on traffic conditions associated with the network. In some aspects, UE 120 may determine the set of parameters. For example, UE 120 may determine the set of parameters based at least in part on traffic conditions, channel conditions, capabilities of UE 120, and/or the like.

As shown by reference number 415, UE 120 may determine an initial ITT value (ITTᵢₙᵢₜᵢₐₗ). Here, the initial ITT value is equal to ITT_{ref}. This may be based at least in part on traffic conditions, channel conditions, a vehicle density threshold, and/or the like.

As shown by reference number 420, UE 120 may determine a final ITT value (e.g., ITT_{final}). As shown, UE 120 may determine the final ITT value using Equation 2:

ITT_{final}=max(min(ITT_{adj},ITTₘₐₓ),ITTₘᵢₙ). Equation 2.

In Equation 2, the lower bound of ITT_{final} is ITTₘᵢₙ. The upper bound is ITTₘₐₓ. ITT_{adj} is the adjusted ITT value determined based at least in part on the motion state. ITT_{adj} may be equal to ITT_{final} assuming that the adjusted ITT value does not fall outside of the range between ITTₘᵢₙ and ITTₘₐₓ. If ITT_{adj} is above ITTₘₐₓ, then ITT_{final} is equal to ITTₘₐₓ. If ITT_{adj} is below ITTₘᵢₙ, then ITT_{final} is equal to ITTₘᵢₙ.

As shown by reference number 425, UE 120 may determine the adjusted ITT value based at least in part on a factor referred to herein as the speed factor. The speed factor may be based at least in part on the motion state of UE 120 or vehicle 405. Here, UE 120 determines ITT_{adj} using Equation 3:

ITT_{adj}=ITTᵢₙᵢₜᵢₐₗ×Speedfactor Equation 3

As shown by reference number 430, the speed factor may be based at least in part on a conditional. The conditional is shown by Equation 4, below:

$$Speedfactor = \{ \begin{matrix}\frac{\begin{matrix}{SpeedTh}_{1} - \\ VehicleSpeed\end{matrix}}{{SpeedTh}_{1}} + 1 & VehicleSpeed < {SpeedTh}_{1} \\ \frac{\begin{matrix}{SpeedTh}_{2} - \\ VehicleSpeed\end{matrix}}{{SpeedTh}_{2}} + 1 & VehicleSpeed > {SpeedTh}_{2} \\ 1 & {SpeedTh}_{1} \leq \\ & VehicleSpeed \leq {SpeedTh}_{2}\end{matrix} . \qquad Equation 4$$

The determination of respective ITTadj and ITTfinal values for vehicles 405-1 and 405-2 are shown by reference numbers 435 and 440. As shown by reference number 435, the speed factor for Vehicle 405-1 may be ≈−0.33 (determined using Equation 4), leading to an ITT_{adj}=150×(1−0.33)=100 ms (determined using Equation 3) and, therefore, an ITT_{final} of 100 ms (determined using Equation 2). As shown by reference number 440, the speed factor for Vehicle 405-2 may be equal to 1, leading to an ITT_{adj}=150×(1)=150 ms and, therefore, an ITT_{final} of 150 ms.

Thus, vehicle 405-1, which is associated with the higher speed, transmits messages more frequently than vehicle 405-2. This reduces congestion in comparison to using the ITT of 100 ms for both vehicles while providing the benefit of more frequent transmission and therefore improved safety for vehicle 405-1.

As another example (not shown in FIG. 4), consider a scenario with vehicles approaching an intersection that does not have a traffic light. Assume that a first vehicle is proceeding straight through the intersection from a first direction, a second vehicle is turning left at the intersection from a second direction, and a third vehicle is turning right at the intersection from a third direction. In this case, the left-turning second vehicle may be associated with a higher risk than the non-turning first vehicle or the right-turning third vehicle. Thus, techniques described herein may adjust the ITT of the second vehicle to be lower than the ITT of the first vehicle or the third vehicle. As an example, UE 120 may use Equations 5 and 6 below, in connection with Equation 2 described above (reproduced here for clarity):

$${ITT}_{final} = max ( min ( {ITT}_{adj} , {ITT}_{max} ) , {ITT}_{min} ) . \qquad Equation 2.$$

$${ITT}_{adj} = {ITT}_{basic} \times Turningfactor . \qquad Equation 5$$

$$Turningfactor = \{ \begin{matrix}0.6 & turn left \\ 0.8 & turn right \\ 1 & go straight\end{matrix} . \qquad Equation 6$$

As shown, Equations 5 and 6 use a turning factor (e.g., a motion state of UE 120) to determine the adjusted ITT. Here, the turning factor is lowest for the left turn, meaning that left-turning vehicles will have a shortest ITT value. For example, UE 120 may determine the adjusted ITT values as shown below:

First Vehicle: Turning factor=1; ITT_{adj}=150×1=150 ms; ITT_{final}=150 ms

Second Vehicle: Turning factor=0.6; ITT_{adj}=150×0.6=90 ms; ITT_{final}=100 ms

Third vehicle: Turning factor=0.8; ITT_{adj}=150×0.8=120 ms; ITT_{final}=120 ms

Thus, the second vehicle, which performs the higher-risk left turn, is associated with a shorter ITT value than the first vehicle or the third vehicle, thus improving safety of the three vehicles. Furthermore, the first vehicle, which proceeds straight through the intersection, is associated with a longer ITT value than the second vehicle or the third vehicle, thereby reducing channel congestion.

In some aspects, UE 120 may adjust the inter-transmission time value to equal an elapsed time since a previous transmission, of the series of transmissions, based at least in part on the motion state satisfying a threshold. For example, UE 120 may transmit a transmission in connection with the motion state satisfying the threshold. In some aspects, UE 120 may transmit the transmission immediately after the motion state satisfies the threshold. This may enable the notification of other UEs or vehicles of the UE 120 satisfying the threshold before an inter-transmission time value has elapsed, thereby improving safety.

As indicated above, FIG. 4 is provided as an example. Other examples may differ from what is described with respect to FIG. 4.

FIG. 5 is a diagram illustrating an example process 500 performed, for example, by a UE, in accordance with various aspects of the present disclosure. Example process 500 is an example where the UE (e.g., UE 120 and/or the like) performs operations associated with congestion control based at least in part on a motion state of the UE.

As shown in FIG. 5, in some aspects, process 500 may include determining an inter-transmission time value for a series of transmissions to be performed by the UE (block 510). For example, the UE (e.g., using controller/processor 280 and/or the like) may determine an inter-transmission time value for a series of transmissions to be performed by the UE, as described above.

As further shown in FIG. 5, in some aspects, process 500 may include adjusting the inter-transmission time value based at least in part on a motion state associated with the UE (block 520). For example, the UE (e.g., using controller/processor 280, transmit processor 264, TX MIMO processor 266, MOD 254, antenna 252, and/or the like) may adjust the inter-transmission time value based at least in part on a motion state associated with the UE, as described above.

As further shown in FIG. 5, in some aspects, process 500 may include performing the series of transmissions in accordance with the adjusted inter-transmission time value (block 530). For example, the UE (e.g., using controller/processor 280, transmit processor 264, TX MIMO processor 266, MOD 254, antenna 252, and/or the like) may perform the series of transmissions in accordance with the adjusted inter-transmission time value, as described above.

Process 500 may include additional aspects, such as any single aspect or any combination of aspects described below and/or in connection with one or more other processes described elsewhere herein.

In a first aspect, determining the inter-transmission time value is based at least in part on a state of a channel associated with the UE.

In a second aspect, alone or in combination with the first aspect, the state of the channel relates to at least one of: a vehicle density threshold, transmissions by one or more other UEs, or a transmitter density.

In a third aspect, alone or in combination with one or more of the first and second aspects, the motion state relates to at least one of: a speed associated with the UE, a direction associated with the UE, a rotational speed associated with the UE, or an acceleration associated with the UE.

In a fourth aspect, alone or in combination with one or more of the first through third aspects, the inter-transmission time value is adjusted to a shorter time value when the motion state indicates a relatively higher speed associated with the UE, and the inter-transmission time value is adjusted to a longer time value when the motion state indicates a relatively lower speed associated with the UE.

In a fifth aspect, alone or in combination with one or more of the first through fourth aspects, the inter-transmission time value is adjusted to a shorter time value when the motion state indicates a relatively higher acceleration associated with the UE, and the inter-transmission time value is adjusted to a longer time value when the motion state indicates a relatively lower acceleration associated with the UE.

In a sixth aspect, alone or in combination with one or more of the first through fifth aspects, the inter-transmission time value is adjusted to a shorter time value when the motion state indicates a relatively higher rate of rotation associated with the UE, and the inter-transmission time value is adjusted to a longer time value when the motion state indicates a relatively lower rate of rotation associated with the UE.

In a seventh aspect, alone or in combination with one or more of the first through sixth aspects, adjusting the inter-transmission time value based at least in part on the motion state associated with the UE further comprises: adjusting the inter-transmission time based at least in part on one or more threshold speed values.

In an eighth aspect, alone or in combination with one or more of the first through seventh aspects, adjusting the inter-transmission time value based at least in part on the motion state associated with the UE further comprises: adjusting the inter-transmission time based at least in part on a direction associated with a turn performed by a vehicle associated with the UE.

In a ninth aspect, alone or in combination with one or more of the first through eighth aspects, one or more parameters used to adjust the inter-transmission time value are configured for the UE by a network or are configured on an on-board unit of the UE.

In a tenth aspect, alone or in combination with one or more the first through ninth aspects, process 500 may include adjusting the inter-transmission time value to equal an elapsed time since a previous transmission, of the series of transmissions, based at least in part on the motion state satisfying a threshold

Although FIG. 5 shows example blocks of process 500, in some aspects, process 500 may include additional blocks, fewer blocks, different blocks, or differently arranged blocks than those depicted in FIG. 5. Additionally, or alternatively, two or more of the blocks of process 500 may be performed in parallel.

The foregoing disclosure provides illustration and description, but is not intended to be exhaustive or to limit the aspects to the precise form disclosed. Modifications and variations may be made in light of the above disclosure or may be acquired from practice of the aspects.

As used herein, the term “component” is intended to be broadly construed as hardware, firmware, or a combination of hardware and software. As used herein, a processor is implemented in hardware, firmware, or a combination of hardware and software.

Some aspects are described herein in connection with thresholds. As used herein, satisfying a threshold may refer to a value being greater than the threshold, greater than or equal to the threshold, less than the threshold, less than or equal to the threshold, equal to the threshold, not equal to the threshold, and/or the like.

It will be apparent that systems and/or methods described herein may be implemented in different forms of hardware, firmware, or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items, and may be used interchangeably with “one or more.” Furthermore, as used herein, the terms “set” and “group” are intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” and/or the like are intended to be open-ended terms. Further, the phrase “based on” is intended to mean “based, at least in part, on” unless explicitly stated otherwise.

What is claimed is:

1. A method of wireless communication performed by a user equipment (UE), comprising:
determining an inter-transmission time value for a series of transmissions to be performed by the UE;
adjusting the inter-transmission time value based at least in part on a motion state associated with the UE; and
performing the series of transmissions in accordance with the adjusted inter-transmission time value.

2. The method of claim 1, wherein determining the inter-transmission time value is based at least in part on a state of a channel associated with the UE.

3. The method of claim 2, wherein the state of the channel relates to at least one of:
a vehicle density threshold,
transmissions by one or more other UEs, or
a transmitter density.

4. The method of claim 1, wherein the motion state relates to at least one of:
a speed associated with the UE,
a direction associated with the UE,
a rotational speed associated with the UE, or
an acceleration associated with the UE.

5. The method of claim 1, wherein the inter-transmission time value is adjusted to a shorter time value when the motion state indicates a relatively higher speed associated with the UE, and wherein the inter-transmission time value is adjusted to a longer time value when the motion state indicates a relatively lower speed associated with the UE.

6. The method of claim 1, wherein the inter-transmission time value is adjusted to a shorter time value when the motion state indicates a relatively higher acceleration associated with the UE, and wherein the inter-transmission time value is adjusted to a longer time value when the motion state indicates a relatively lower acceleration associated with the UE.

7. The method of claim 1, wherein the inter-transmission time value is adjusted to a shorter time value when the motion state indicates a relatively higher rate of rotation associated with the UE, and wherein the inter-transmission time value is adjusted to a longer time value when the motion state indicates a relatively lower rate of rotation associated with the UE.

8. The method of claim 1, wherein adjusting the inter-transmission time value based at least in part on the motion state associated with the UE further comprises:
adjusting the inter-transmission time based at least in part on one or more threshold speed values.

9. The method of claim 1, wherein adjusting the inter-transmission time value based at least in part on the motion state associated with the UE further comprises:
adjusting the inter-transmission time based at least in part on a direction associated with a turn performed by a vehicle associated with the UE.

10. The method of claim 1, wherein one or more parameters used to adjust the inter-transmission time value are configured for the UE by a network or are configured on an on-board unit of the UE.

11. The method of claim 1, wherein adjusting the inter-transmission time value based at least in part on the motion state associated with the UE further comprises:
adjusting the inter-transmission time value to equal an elapsed time since a previous transmission, of the series of transmissions, based at least in part on the motion state satisfying a threshold.

12. A user equipment (UE) for wireless communication, comprising:
a memory; and
one or more processors operatively coupled to the memory, the memory and the one or more processors configured to:
determine an inter-transmission time value for a series of transmissions to be performed by the UE;
adjust the inter-transmission time value based at least in part on a motion state associated with the UE; and
perform the series of transmissions in accordance with the adjusted inter-transmission time value.

13. The UE of claim 12, wherein determining the inter-transmission time value is based at least in part on a state of a channel associated with the UE.

14. The UE of claim 13, wherein the state of the channel relates to at least one of:
a vehicle density threshold,
transmissions by one or more other UEs, or
a transmitter density.

15. The UE of claim 12, wherein the motion state relates to at least one of:
a speed associated with the UE,
a direction associated with the UE,
a rotational speed associated with the UE, or
an acceleration associated with the UE.

16. The UE of claim 12, wherein the inter-transmission time value is adjusted to a shorter time value when the motion state indicates a relatively higher speed associated with the UE, and wherein the inter-transmission time value is adjusted to a longer time value when the motion state indicates a relatively lower speed associated with the UE.

17. The UE of claim 12, wherein the inter-transmission time value is adjusted to a shorter time value when the motion state indicates a relatively higher acceleration associated with the UE, and wherein the inter-transmission time value is adjusted to a longer time value when the motion state indicates a relatively lower acceleration associated with the UE.

18. The UE of claim 12, wherein the inter-transmission time value is adjusted to a shorter time value when the motion state indicates a relatively higher rate of rotation associated with the UE, and wherein the inter-transmission time value is adjusted to a longer time value when the motion state indicates a relatively lower rate of rotation associated with the UE.

19. The UE of claim 12, wherein the one or more processors, when adjusting the inter-transmission time value based at least in part on the motion state associated with the UE wherein the one or more processors, are further configured to:
adjust the inter-transmission time based at least in part on one or more threshold speed values.

20. The UE of claim 12, wherein the one or more processors, when adjusting the inter-transmission time value based at least in part on the motion state associated with the UE wherein the one or more processors, are further configured to:
adjust the inter-transmission time based at least in part on a direction associated with a turn performed by a vehicle associated with the UE.

21. The UE of claim 12, wherein the one or more processors, when adjusting the inter-transmission time value based at least in part on the motion state associated with the UE, are further to:
adjust the inter-transmission time value to equal an elapsed time since a previous transmission, of the series of transmissions, based at least in part on the motion state satisfying a threshold.

22. A non-transitory computer-readable medium storing one or more instructions for wireless communication, the one or more instructions comprising:
one or more instructions that, when executed by one or more processors of a user equipment (UE), cause the one or more processors to:
determine an inter-transmission time value for a series of transmissions to be performed by the UE;
adjust the inter-transmission time value based at least in part on a motion state associated with the UE; and
perform the series of transmissions in accordance with the adjusted inter-transmission time value.

23. The non-transitory computer-readable medium of claim 22, wherein determining the inter-transmission time value is based at least in part on a state of a channel associated with the UE.

24. The non-transitory computer-readable medium of claim 23, wherein the state of the channel relates to at least one of:
a vehicle density threshold,
transmissions by one or more other UEs, or
a transmitter density.

25. The non-transitory computer-readable medium of claim 22, wherein the motion state relates to at least one of:
a speed associated with the UE,
a direction associated with the UE,
a rotational speed associated with the UE, or
an acceleration associated with the UE.

26. The non-transitory computer-readable medium of claim 22, wherein the inter-transmission time value is adjusted to a shorter time value when the motion state indicates a relatively higher speed associated with the UE, and wherein the inter-transmission time value is adjusted to a longer time value when the motion state indicates a relatively lower speed associated with the UE.

27. The non-transitory computer-readable medium of claim 22, wherein the inter-transmission time value is adjusted to a shorter time value when the motion state indicates a relatively higher acceleration associated with the UE, and wherein the inter-transmission time value is adjusted to a longer time value when the motion state indicates a relatively lower acceleration associated with the UE.

28. The non-transitory computer-readable medium of claim 22, wherein the inter-transmission time value is adjusted to a shorter time value when the motion state indicates a relatively higher rate of rotation associated with the UE, and wherein the inter-transmission time value is adjusted to a longer time value when the motion state indicates a relatively lower rate of rotation associated with the UE.

29. The non-transitory computer-readable medium of claim 22, wherein the one or more instructions, that cause the one or more processors to adjust the inter-transmission time value based at least in part on the motion state associated with the UE, further cause the one or more processors to:
adjust the inter-transmission time based at least in part on one or more threshold speed values.

30. The non-transitory computer-readable medium of claim 22, wherein the one or more instructions, that cause the one or more processors to adjust the inter-transmission time value based at least in part on the motion state associated with the UE, further cause the one or more processors to:
adjust the inter-transmission time based at least in part on a direction associated with a turn performed by a vehicle associated with the UE.

31. The non-transitory computer-readable medium of claim 22, wherein the one or more instructions, that cause the one or more processors to adjust the inter-transmission time value based at least in part on the motion state associated with the UE, further cause the one or more processors to:
adjust the inter-transmission time value to equal an elapsed time since a previous transmission, of the series of transmissions, based at least in part on the motion state satisfying a threshold.

32. An apparatus for wireless communication, comprising:
means for determining an inter-transmission time value for a series of transmissions to be performed by the apparatus;
means for adjusting the inter-transmission time value based at least in part on a motion state associated with the apparatus; and
means for performing the series of transmissions in accordance with the adjusted inter-transmission time value.

33. The apparatus of claim 32, wherein determining the inter-transmission time value is based at least in part on a state of a channel associated with the apparatus.

34. The apparatus of claim 33, wherein the state of the channel relates to at least one of:
a vehicle density threshold,
transmissions by one or more UEs, or
a transmitter density.

35. The apparatus of claim 32, wherein the means for adjusting the inter-transmission time value based at least in part on the motion state associated with the UE further comprises:
means for adjusting the inter-transmission time value to equal an elapsed time since a previous transmission, of the series of transmissions, based at least in part on the motion state satisfying a threshold.
